(19) United States
(12) Patent Application Publication
(10) Pub. No.: US 2005/0108572 A1
(43) Pub. Date: May 19, 2005

(54) Electronic document confidentiality system

(76) Inventor: Kevin C. Flynn, Mt. Laurel, NJ (US)

Correspondence Address: Kevin Flynn, 1606 Stokes Rd, Mt. Laurel, NJ, 08054, US

(21) Appl. No.: 10/919,031

(22) Filed: Aug. 14, 2004

Related U.S. Application Data
(60) Provisional application No. 60/495,041, filed on Aug. 14, 2003.
(60) Provisional application No. 60/511,595, filed on Oct. 16, 2003.

(51) Int. Cl. G06F 12/14

(52) U.S. Cl. 713/201

(57) ABSTRACT

Method and apparatus to ensure the confidentiality of electronic documents by tracking the accessing/use of electronic documents.

### RELATED APPLICATIONS

This application claims priority under 35 USC sec. 119(e) to U.S. Provisional Application Ser. No. 60/495041, filed Aug. 14, 2003, entitled “Electronic Document Tracking System” This application also claims priority under 35 USC sec. 119(e) to U.S. Provisional Application Ser. No. 60/511,595, Filed Oct. 16, 2003, entitled “Electronic document tracking system” The two (2) above-referenced provisional patent applications are incorporated herein in their entirety by this reference.

### FIELD OF THE INVENTION

The present invention relates generally to electronic documents and a system and method to maintain their confidentiality.

### SUMMARY

Modern businesses use electronic documents and email to efficiently conduct business. The problem this that electronic documents are easily sent anywhere in the world and once sent, the owner cannot track where the document goes or to whom it is sent. The document(s) could contain trade secrets or proprietary data and be sent to a competitor. Or, electronic documents can be taken from a business, person, government entity or other without their knowledge and identifying the theft would be very difficult to discover. By using the Electronic Document Tracking System, an owner of an electronic document can have a good probability of knowing where the document is in the virtual world of computers, who is accessing it and when.

### DESCRIPTION

### Background of the Invention

Electronic documents can contain sensitive information including trade secrets, client lists, etc. This kind of information is imperative to the profitability and functioning of companies, governments, etc. To date, there is no way to automatically track when and where (a/k/a by whom) your documents were accessed. The Electronic Document Tracking System is a system that overcomes that void in modern technology.

While most word processors, and other programs, have a mechanism to password protect the document, and encryption software does exist, these implementations are cumbersome and sometimes require third-party software. The “electronic document tracking system” incorporates an encryption mechanism to provide a secure document and ensure that the document is tracked. Furthermore, the encryption mechanism will not require third-party software or passwords that are easily lost. Instead, the encryption mechanism will work off a list of IP addresses (or other hardware addresses that is computer specific) that are considered “secure” to the document owner.

### BRIEF DESCRIPTION OF THE DRAWINGS

Not applicable.

### DETAILED DESCRIPTION OF THE INVENTION

### Accessing and Tracking

The method and apparatus include embedding, in the electronic document, an electronic program, script or macro that encrypts the document and contacts the document owner's company, or a third party entity, upon accessing the electronic document.

Upon opening the electronic document, the embedded program, script or macro will contact the owner via electronic messaging. The contact may be via the Internet whereby the embedded program, script or macro containing a specific encrypted document tracking number (i.e. placement of a VBA script in Microsoft documents) can do an HTML call via a “get” statement to the owners web site where the “get” statement requests the IP address (or other unique address specific to the computer) of the machine on which the electronic document currently exists and the unencrypted unique document number (this would result in an error in the web servers web logs leaving behind the IP address of the computer accessing the document and the unique unencrypted document tracking number.). This method will provide a web log with the details of when and where the electronic document lies in cyberspace and who is accessing it.

Another method is to setup a server and assign it a specific port (socket server or SOAP server) that accepts data via the Internet. Once the program, script or macro verifies the IP address of the computer accessing the electronic document against the “approved IP address list,” the program will send a message to the sever including the IP address (or other hardware addresses that is computer specific) of the computer where the document is located in Cyberspace and the electronic document tracking number.

Once the encrypted electronic document has contacted the “server” the server will verify the data passed against its database and pass back a number that is associated with the document number to be utilized with the “one page encryption” software [as a matter of background, one page encryption was used by the Russians after WW2. While the One-Page encryption algorithm is noted here, any encryption algorithm may be used]. Once the electronic document has received the One Page encryption number, the document will self-decrypt and be accessible to the end-user.

The point of incorporating encryption software with a tracking system is to ensure the tracking. That is, if a person simply opened the document on a machine that is not connected to the Internet, they could simple bypass the Internet Tracking Feature. By having the One-Page encryption number given by the server, the device has built-in a guarantee that the electronic document must contact the Tracking Server otherwise the document will not decrypt. The encryption also acts as additional layer of document security.

Another implementation of this methodology is for the company that develops the software to develop its own database that is accessible via the Internet. Then, the software company would contract, for a fee, with the clients and all of the documents would contact the software company's database and the software company would be responsible for tracking access to the documents and providing access information to the electronic document owner. The implementation of the software company's database would simply be a scalable version of the web site or unique port implementation used by the owner's of the electronic documents.

To embed the tracking program/script/macro, and the electronic document tracking number, into the electronic document the user would use a program that allows the user to navigate his or her computer to select the document they want protected. Once identified, the program would insert the embedded program/script/macro and unique encrypted document-tracking number into the electronic document. An example of such an implementation would be embedding a VBA script into Microsoft Documents. The program, script or macro could be configured to contact the owner's web site or the server (Socket or SOAP server) that the owner implemented at their entity (i.e. business, government, etc.).

Prior to the “navigating program” inserting the program/script/macro into the electronic document, the “navigation program” would create an entry in the owner's database that links the documents name and where it was to be used/sent, with a unique identifier number and a One-Page encryption number that is associated with the document or owner. Additionally, the document owner will be prompted for “activation” and “deactivations” dates. These dates are the dates when the document will begin to send data back to the owner or stop sending data back to the owner. After all, the electronic document might be time sensitive and the owner may not want the reporting, or access of the document, after one (1) year.

Another possible implementation of inserting the code into the document is by manipulating the “templates” used by the various software programs. Microsoft, WordPerfect and others use templates when starting new documents. By inserting the encryption and tracking code needed into these templates, the system has automated the process of inserting the code into the document.

This same methodology and apparatus may be used in conjunction with marketing. As electronic marketing grows, this system may be used to track how many people read a particular piece of electronic marketing literature. Based on the number of readers, the advertiser will know how effective the marketing campaign is. Also, royalties and other incentive marketing reimbursement mechanisms may be based on the “number of hits” produced by any one electronic marketing piece much like current reimbursement schemes for the Internet's “pay per click” web page referral agreements.

### Document Rights

If the implementation of the tracking system uses the socket or SOAP server method of tracking, the interaction with the document may be extended. Because the electronic document can pass a message over the Internet, it can either expect or not expect a reply message. Such an implementation may be used to approve or deny access to the document being viewed; or the document may be given privileges via the server (socket or SOAP server) to disallow printing of the document or other the document may be instructed to self-delete. While the document may not delete or copies, the implementation will cause a greater level of security for the document.

### Document Encryption

Programs like Microsoft Word and WordPerfect have password protection but passwords can be shared and there are programs that break password protection. To add an additional layer of protection and ensure tracking, The Electronic Document Tracking System will encrypt the electronic document. Upon accessing the document, the program, script or macro (i.e. a Microsoft Word VBA script) would check the IP addresses in the “allowed to access list” and compare them to the IP address (or other hardware addresses that is computer specific) of the computer accessing the document. If they match, the program, script or macro would contact the server (SOAP or socket server) for the One-Page encryption number and decrypt the document.

### IP Address Modual

The people with whom electronic documents are most commonly shared will know the end user's IP address (or other hardware addresses that is computer specific). In the event they do not, a small program, or a program executed from an Internet web page, is given to the end user. The purpose of this program is to determine the IP address of the computer that will be receiving the document. This ensures that the IP address being used in the embedded code is correct.

1. A system and apparatus to ensure the confidentiality of electronic documents via a tracking system.

2. The method of claim 1 utilizing a system and apparatus to track the location of (specific computer being used) the electronic documents in cyberspace via a tracking system.

3. The method and apparatus of claim 2, to track the time and date the electronic document was accessed.

4. The method and apparatus of claim 3 that combines electronic encryption to ensure the tracking of a document by not allowing it to decrypt without proper notification and authentication of the document via an electronic rights management component.
